(19) United States
(12) Patent Application Publication
(10) Pub. No.: US 2004/0017440 A1
(43) Pub. Date: Jan. 29, 2004

(54) Manufacturing method of liquid jet head

(75) Inventors: Hidehito Takayama, Kanagawa (JP); Akihiro Mouri, Tokyo (JP); Nobuhito Yamaguchi, Tokyo (JP); Toshihiro Fukasaka, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/619,004

(22) Filed: Jul. 15, 2003

(30) Foreign Application Priority Data
Jul. 18, 2002 (JP) 2002-209099

(51) Int. Cl. B41J 2/05

(52) U.S. Cl. 347/65

(57) ABSTRACT

A manufacturing method of a liquid jet head, comprising a step of disposing a liquid flow path pattern containing a soluble resin on a substrate and disposing a coating layer containing a resin forming a wall of the liquid flow path so as to coat the liquid flow path pattern, a step of disposing a liquid discharge energy generation element for generating an energy for use in discharging a liquid in a place disposed opposite to the liquid flow path pattern, a step of separating and removing the substrate, and a step of removing the liquid flow path pattern to form the liquid flow path.

### BACKGROUND OF THE INVENTION

1. Field of the Invention

The present invention relates to a manufacturing method of a liquid jet head for discharging/flying droplets to deposit the droplets to a recording medium.

2. Description of the Related Art

A liquid jet head for use in a liquid jet recording system (ink jet print system) generally includes a discharge port (orifice) for discharging liquids such as ink, a liquid flow path connected to the discharge port, and a liquid discharge energy generation element disposed in the liquid flow path. The head has characteristics that generation of noises at a recording time is small to an ignorable degree, high-speed recording and recording with respect to various recording mediums are possible, the recording is fixed even to a so-called plain paper without requiring any special treatment, and a high-precision image is inexpensively obtained. From these advantages, the head has rapidly spread not only in a printer which is a peripheral apparatus of a computer but also in a printing system such as a copying machine, facsimile, and word processor these several years. In these days, for liquid discharge methods of a liquid jet apparatus for broad and general use, there have been a method of using an electrothermal conversion device (heater), and a method of using a piezoelectric element (piezo element). In either method, it is possible to control the discharge of the droplets by an electric signal.

As a method of preparing this liquid jet head, for example, a method has been known in which after forming a fine groove for forming a liquid flow path in a plate of glass or metal by processing means such as cutting and etching, a substrate for the liquid jet head, including a liquid discharge energy generation element, is bonded to the plate in which the groove is formed to form a liquid flow path.

For example, as described in Japanese Patent Application Laid-Open No. 6-255099, it has been known that a vibration plate including a diaphragm portion is laminated on the piezoelectric element as the liquid discharge energy generation element. A liquid chamber to be pressurized by the piezoelectric element through the diaphragm portion and a liquid flow path forming member for forming a liquid flow path to supply the liquid to the liquid chamber are laminated on the vibration plate. Furthermore, a nozzle forming member in which a nozzle hole is formed is laminated on the liquid flow path forming member.

Moreover, for example, as disclosed in Japanese Patent Application Laid-Open No. 6-115071, a plurality of piezoelectric elements which are liquid discharge energy generation elements are bonded/arranged in a row onto the substrate. Furthermore, a liquid common channel member positioned around the piezoelectric element to form a liquid common channel is bonded. The vibration plate is bonded onto the liquid common channel member, a partition wall member is bonded onto the vibration plate, a nozzle plate is bonded onto the partition wall member, and a liquid chamber (pressurized liquid chamber) to be pressurized through the vibration plate by the piezoelectric element is formed by these vibration plate, partition wall member, and nozzle plate.

Furthermore, for example, as described in Japanese Patent Application Laid-Open No. 8-142324, a plurality of piezoelectric elements are bonded in a plurality of rows onto the substrate, and a frame member positioned around the piezoelectric element is also bonded so that an actuator unit is constituted. A liquid chamber partition wall member for forming a pressurized liquid chamber to be pressurized by the piezoelectric element through the diaphragm portion and a common liquid chamber to supply the liquid to this liquid chamber is laminated on the vibration plate which includes the diaphragm portion. Furthermore, the nozzle plate in which the nozzle is formed is laminated on the liquid chamber partition wall member to form a liquid chamber unit. The liquid chamber unit is bonded to the actuator unit.

Additionally, for example, as described in Japanese Patent Application Laid-Open No. 6-297704, a photosensitive resin is used as the liquid chamber partition wall member to bond a plurality of photosensitive resin layers so that the liquid chamber is formed. Alternatively, another resin molding is performed, or a multiplicity of layers of metal plates are bonded to one another so as to form a fine liquid chamber.

However, in the above-described conventional manufacturing method of the liquid jet head, when the groove forming the liquid flow path is formed by a cutting step, it is difficult to smoothen an inner wall surface of the groove. Moreover, the plate easily cracks or breaks, and yield is not very good. On the other hand, when the groove is formed by etching, it is difficult to uniform an etching state with respect to all the grooves for forming the liquid flow paths. There are also disadvantages that a process is complicated and manufacturing cost is raised. In this manner, it is difficult to constantly prepare the liquid jet head including the uniform liquid flow path even by any processing means, and the obtained liquid jet head tends to have unevenness in print characteristics. Furthermore, when bonding the plate in which the groove for forming the liquid flow path is formed to the substrate for the liquid jet head, in which the liquid discharge energy generation element is disposed, it has been difficult to position the groove and liquid discharge energy generation element with good precision. Therefore, the above-described conventional manufacturing method has not been suitable for mass production of high-quality liquid jet heads.

As described above, in the related art, various steps are carried out in the manufacturing method of the liquid jet head. However, in any step, it has been a problem to form a high-precision liquid flow path. Moreover, even if the high-precision liquid flow path can be formed, it has been a problem to exactly position the liquid flow path with respect to the liquid discharge energy generation element.

### SUMMARY OF THE INVENTION

One of objects of the present invention is to provide a manufacturing method of a liquid jet head in which a liquid flow path is formed with a high precision, the liquid flow path and a liquid discharge energy generation element can exactly be positioned, and productivity of the liquid jet head of high grade can be enhanced.

According to the present invention, there is provided a manufacturing method of a liquid jet head, comprising: a step of disposing a liquid flow path pattern containing a soluble resin on a substrate and disposing a coating layer containing a resin forming a wall of the liquid flow path so as to coat the liquid flow path pattern; a step of disposing a liquid discharge energy generation element for generating an energy for use in discharging a liquid in a place disposed opposite to the liquid flow path pattern; a step of separating and removing the substrate; and a step of removing the liquid flow path pattern to form the liquid flow path.

According to the present invention, the liquid discharge energy generation element is disposed before removing the substrate which is a member having a relatively high strength. Thereafter, the substrate is removed. Therefore, the liquid jet head having high reliability can be manufactured. Additionally, after the substrate is removed, the liquid flow path pattern is removed to form the liquid flow path. Therefore, the forming of the highly precise liquid flow path by the removal of the liquid flow path pattern is carried out relatively later in a flow of the manufacturing steps. This is preferable because a possibility of invasion of foreign particles into the liquid flow path is reduced and the reliability of the head is further enhanced.

In the present invention, a photosensitive resin which contributes to the forming of the liquid flow path is formed on the substrate, and further a resin for coating is formed on the photosensitive resin. Thereafter, when the photosensitive resin of a liquid flow path portion is dissolved/removed to form the liquid flow path, the liquid flow path with a higher precision can be formed.

Moreover, when a convex portion extending onto a liquid pressurizing chamber in a longitudinal direction is formed with a high precision, and a liquid flow path constituting member is formed by a resin having optical transmission, the positioning of the liquid discharge energy generation element and liquid pressurizing chamber can correctly and easily be performed.

Accordingly, it is possible to prepare the liquid jet head of the high grade with a high yield, and productivity in the manufacturing of the liquid jet head can remarkably be enhanced.

### BRIEF DESCRIPTION OF THE DRAWINGS

FIG. 1 is a perspective view showing a liquid jet head prepared by a manufacturing method of the liquid jet head according to the present invention in a partially broken state seen from a side of a piezoelectric element which is a liquid discharge energy generation element;

FIGS. 2A, 2B, 2C, 2D, 2E, 2F, 2G, 2H, 2I, 2J, 2K, 2L and 2M show schematic step diagrams showing major steps of a first embodiment of the manufacturing method of the liquid jet head according to the present invention in sections;

FIGS. 3A, 3B, 3C, 3D, 3E, 3F, 3G, 3H, 3I, 3J, 3K, 3L and 3M show schematic step diagrams showing the major steps of a second embodiment of the manufacturing method of the liquid jet head according to the present invention in the section; and

FIGS. 4A, 4B, 4C, 4D, 4E, 4F, 4G, 4H, 4I, 4J and 4K show schematic step diagrams showing the major steps of a third embodiment of the manufacturing method of the liquid jet head according to the present invention in the sections.

### DESCRIPTION OF THE PREFERRED EMBODIMENTS

Embodiments of the present invention will be described hereinafter with reference to the drawings.

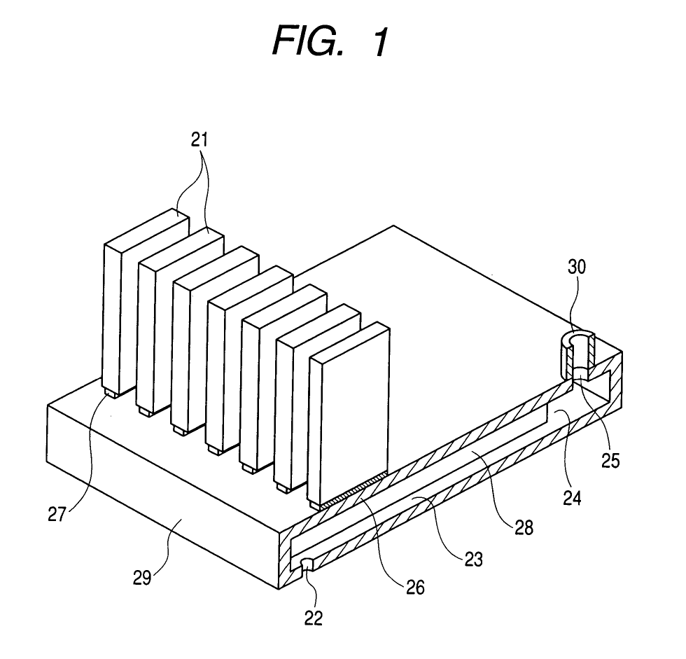

FIG. 1 is a perspective view showing a liquid jet head prepared by a manufacturing method of the liquid jet head according to the present invention in a partially broken state seen from a side of a piezoelectric element which is a liquid discharge energy generation element.

As shown in FIG. 1, the liquid jet head prepared by the manufacturing method of the liquid jet head according to the present invention includes: piezoelectric elements 21 which are liquid discharge energy generation elements to generate a pressure for discharging a liquid; a liquid discharge port 22 for discharging the liquid; a liquid pressurizing chamber 23 for containing and pressurizing the liquid to be discharged; a liquid supply path 24 connected to each liquid pressurizing chamber 23; a liquid supply port 25, connected to the liquid supply path 24, for supplying the liquid; a vibration plate 26 for pressurizing the liquid pressurizing chamber 23; and bond portions 27 which are disposed to bond the vibration plate 26 to the piezoelectric element 21 and which extend in a longitudinal direction of the liquid pressurizing chamber 23 and which include convex portions, so-called island structures. A plurality of liquid pressurizing chambers 23 are individually separated by partition walls 28 and juxtaposed and formed. Accordingly, a plurality of liquid discharge ports 22 are similarly juxtaposed and formed. A liquid supply member 30 is bonded to the liquid supply port 25 by an adhesive. When the liquid supply member 30 is connected to a liquid tank (not shown), the liquid is supplied. In FIG. 1, reference numeral 29 is a liquid flow path constituting member which constitutes a liquid flow path including the liquid pressurizing chamber 23 and liquid supply path 24, and the vibration plate 26.

In the present embodiment, in the piezoelectric element 21 which is the liquid discharge energy generation element, a piezoelectric element including a structure in which lead zirconate titanate (PZT) as a piezoelectric material and an electrode are laminated is used. Moreover, each piezoelectric element 21 is fixed to a base plate (not shown in FIG. 1), and a plurality of piezoelectric elements are juxtaposed and arranged opposite to the liquid pressurizing chambers 23. In the piezoelectric element 21, an individual electrode for driving (not shown) and common electrode (not shown) are formed. These individual electrode and common electrode are connected to a signal line and common line, respectively, and a driving signal is sent from a driving circuit (not shown).

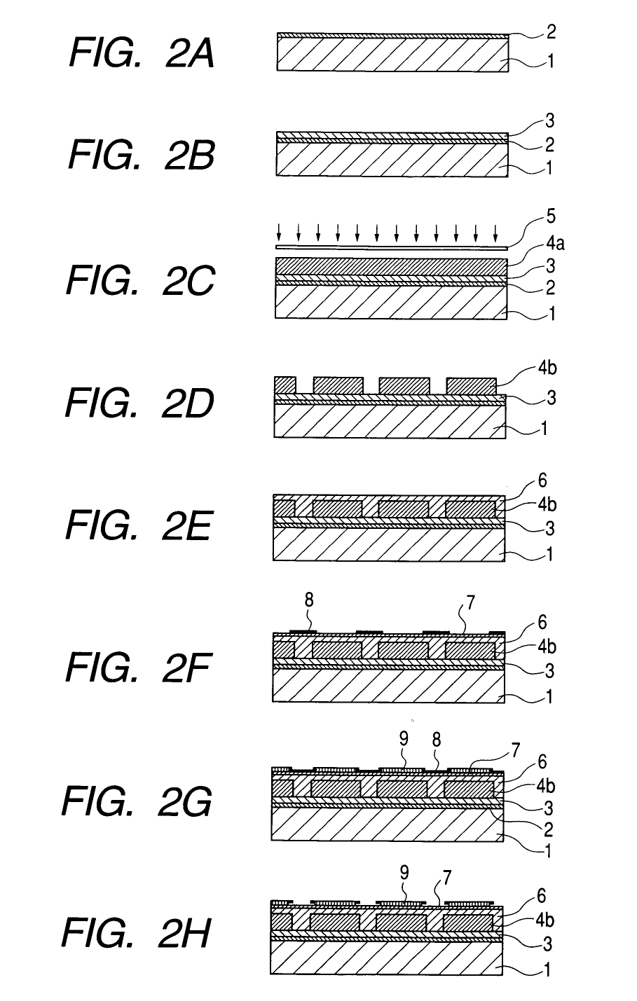

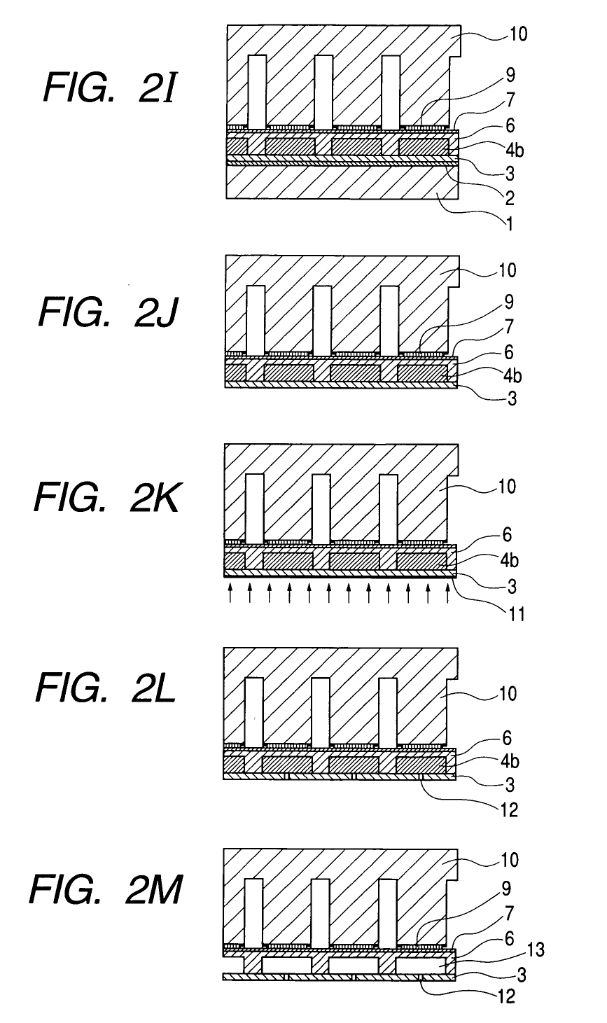

Next, a first embodiment of the manufacturing method of the liquid jet head according to the present invention will be described with reference to FIGS. 2A to 2M. FIGS. 2A to 2M show schematic step diagrams showing major steps of the first embodiment of the manufacturing method of the liquid jet head according to the present invention in sections.

In FIG. 2A, a 5 mm thick substrate of glass having heat resistance is used as a substrate 1 to form a separating layer 2 on the substrate 1. For the separating layer 2, PET is coated with soluble polymethyl isopropenyl ketone (ODUR-1010 manufactured by Tokyo Ohka Kogyo Co., Ltd.) and dried to form a dry film having a film thickness of 2 μm. The film was laminated and accordingly transferred onto the substrate 1. It is to be noted that ODUR-1010 has low viscosity and cannot be formed into a thick film, and was therefore condensed and used. Next, the substrate was pre-baked at 120° C. for 20 minutes.

Next, as shown in FIG. 2B, in order to form a part of the liquid flow path constituting member (29) constituting the partition wall of the liquid flow path (corresponding to the members shown by reference numerals 23, 24 in FIG. 1. The reference numerals of the members shown in FIG. 1 will similarly be shown hereinafter in parentheses.), a first coat resin layer 3 having a film thickness of 5 μm is formed on the separating layer 2 by spin coat or roll coat. As the first coat resin layer 3, a resin composition containing 100 parts of an epoxy resin (o-cresol novolak type epoxy resin), one part of a photo cation polymerization initiator (4,4-di-t-butylphenyl iodonium hexafluoroantimonate), and 10 parts of a silane coupling agent (A-187 manufactured by Nihon Yunika Co.) is dissolved in a methyl isobutyl ketone/xylene mixture liquid at a concentration of 50 wt %. The first coat resin layer 3 having a film thickness of 5 μm and having photosensitivity was formed on the separating layer 2 by the spin coat and subsequently exposed to be cured.

Next, as shown in FIG. 2C, a soluble resin layer 4a having a film thickness of 10 μm is formed on the first coat resin layer 3 in order to form the liquid pressurizing chamber (23) and liquid supply path (24). For the resin layer 4a, PET is coated with soluble polymethyl isopropenyl ketone (ODUR-1010 manufactured by Tokyo Ohka Kogyo Co., Ltd.) and dried to form a dry film having a film thickness of 10 μm. The film was laminated and accordingly transferred onto the first coat resin layer 3. It is to be noted that ODUR-1010 has low viscosity and cannot be formed into the thick film, and was therefore condensed and used. Next, the layer was pre-baked at 120° C. for 20 minutes.

Thereafter, a mask 5 is used to expose the pattern of the liquid flow path by a mask aligner PLA520 (cold mirror CM290) manufactured by Cannon Inc. The exposure was carried out for 1.5 minute, methyl isobutyl ketone/xylene=2/1 was used for development, and xylene was used for rinse. Accordingly, as shown in FIG. 2D, a pattern 4b is formed by a soluble resin, and this pattern 4b is formed in order to secure the liquid pressurizing chamber (23) and liquid supply path (24).

Next, as shown in FIG. 2E, in order to form a part of the vibration plate (26), partition wall (28) of the liquid flow path, or liquid flow path constituting member (29), a second coat resin layer 6 having a film thickness of 5 μm on the pattern 4b is formed on the pattern 4b by the spin coat or roll coat. As the second coat resin layer 6, the resin composition containing 100 parts of the epoxy resin (o-cresol novolak type epoxy resin), one part of the photo cation polymerization initiator (4,4-di-tbutylphenyl iodonium hexafluoroantimonate), and 10 parts of the silane coupling agent (A-187 manufactured by Nihon Yunika Co.) is dissolved in the methyl isobutyl ketone/xylene mixture liquid at the concentration of 50 wt %. The second coat resin layer 6 having a film thickness of 5 μm and having photosensitivity was formed on the pattern 4b by the spin coat and subsequently exposed to be cured.

Next, as shown in FIGS. 2F to 2H, the bond portion (27) for bonding the piezoelectric element is formed on the second coat resin layer 6. For this, first, as shown in FIG. 2F, an electrode layer 7 is formed by electroless plating. Subsequently, a non-conductive photo resist layer having a film thickness of 5 μm is applied, and a pattern 8 is formed so as to agree with a shape of a bottom of the bond portion (27). Next, this is immersed in an electrolysis liquid for electroforming containing an aqueous liquid nickel ion containing 30 wt % of nickel sulfamate, 0.5 wt % of nickel chloride, 4 wt % of boric acid, 1 wt % of a brightener, and 0.5 wt % of a pit preventive agent. The electrode layer 7 is used as a minus pole, and the electroforming is carried out at a current density of about 2 mA/cm². As a result, as shown in FIG. 2G, nickel in the electrolysis liquid is selectively deposited in a portion of the pattern 8 in which a photo resist layer is not formed, and the thickness of this portion increases. When the height of the pattern 8 of the photo resist layer was projected, and the pattern was developed to obtain a thickness of 18 μm, an overhang having a length of 10 μm was generated even in the surface direction of the pattern 8 of the photo resist layer by an edge effect, and electric conduction was stopped. Next, as shown in FIG. 2H, the pattern 8 of the photo resist layer was washed away to form a bond portion 9 including an island structure whose section was of a rivet type.

Next, as shown in FIG. 2I, an epoxy-based adhesive is used to bond a piezoelectric element 10 to the bond portion 9 including the island structure. During the bonding of the piezoelectric element 10, since the substrate 1 or resin layer other than the bond portion 9 has optical transmission, an alignment mark (not shown) formed on the piezoelectric element 10 is observed from a substrate 1 side with a stereomicroscope, and the piezoelectric element 10 can be bonded. As the stereomicroscope, SZH-10 (trade name) manufactured by Nikon Corp. was used. In this case, the position of the piezoelectric element 10 can accurately be determined with respect to the bond portion 9, and position accuracy can be enhanced. After bonding the device through the epoxy-based adhesive, the device was pre-baked at 120° C. for 20 minutes.

Next, as shown in FIG. 2J, an ultrasonic wave is applied into methyl isobutyl ketone while immersing the material, the separating layer 2 between the substrate 1 and first coat resin layer 3 is eluted, and the substrate 1 is separated.

Next, as shown in FIGS. 2K and 2L, the liquid discharge port (22) is formed. First, as shown in FIG. 2K, the surface of the first coat resin layer 3 is coated with a silicon-containing positive resist 11 (FH-SP (trade name) manufactured by Fuji Hunt Co., Ltd.), and the liquid discharge port (22) is patterned. Subsequently, an excimer laser is used to irradiate the pattern through the mask. Accordingly, a liquid discharge port 12 is formed in the first coat resin layer 3 by laser abrasion. It is to be noted that the laser abrasion was ended at an arbitrary point in the soluble resin layer 4b.

Next, as shown in FIG. 2M, the ultrasonic wave is applied into methyl isobutyl ketone while immersing the layers, the soluble pattern resin layer 4b is eluted, and a liquid flow path 13 (liquid pressurizing chamber (23) or liquid supply path (24)) is formed.

With respect to the liquid flow path 13 constituting the liquid pressurizing chamber (23) and liquid supply path (24) and the piezoelectric element 10 (21) formed in this manner, the liquid supply member (30) for supplying the liquid is bonded and the signal line and common line for driving the piezoelectric element 10 (21) which is a liquid discharge pressure generation device are electrically bonded so that the liquid jet head is completed.

The liquid jet head prepared in this manner was mounted on a liquid jet apparatus, and ink containing pure water/diethylene glycol/isopropyl alcohol/lithium acetate/black dyestuff food black 2=79.4/15/3/0.1/2.5 was used to perform the printing/recording. Then, stable printing was possible, and an obtained printed matter was of a high grade.

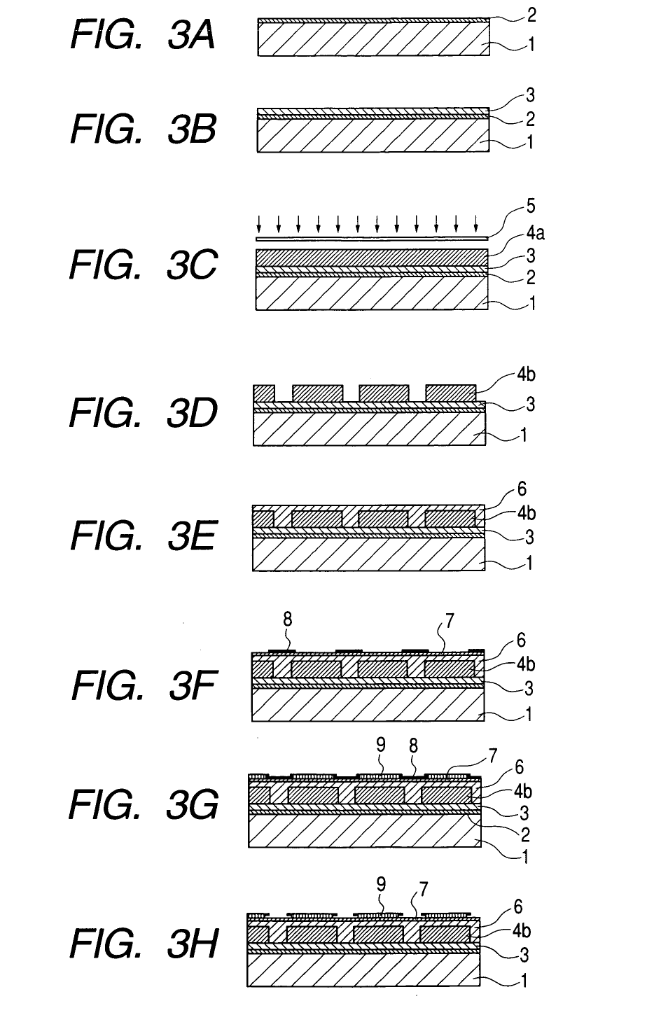

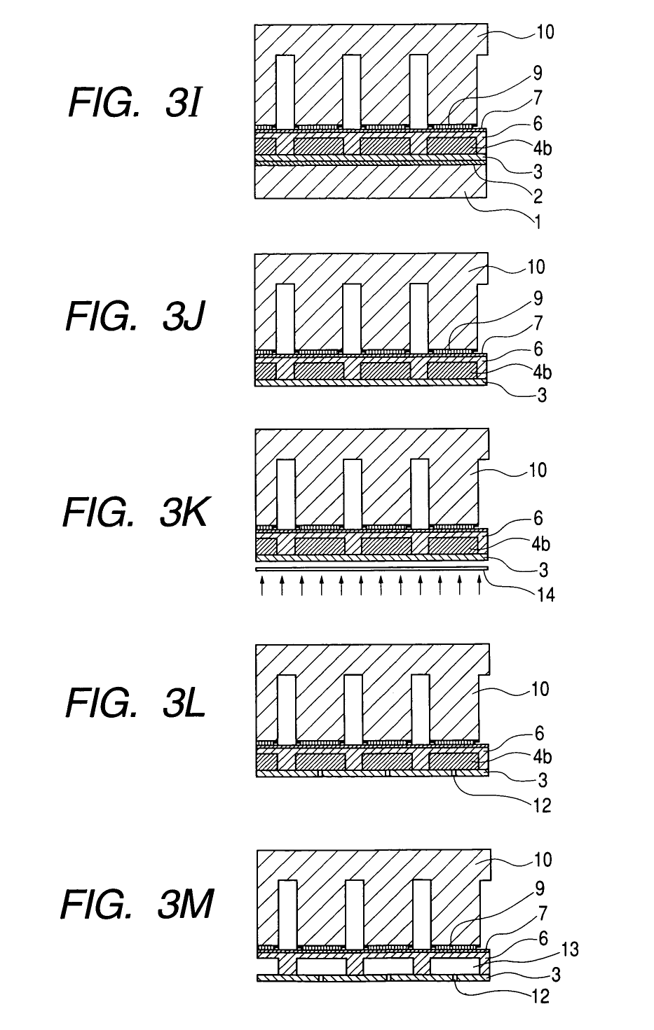

Next, a second embodiment of the manufacturing method of the liquid jet head according to the present invention will be described with reference to FIGS. 3A to 3M. FIGS. 3A to 3M show schematic step diagrams showing the major steps of the present embodiment in sections.

The present embodiment is different from the first embodiment only in that oxygen plasma etching is used in the forming step of the liquid discharge port (22), the other steps are similar to those in the first embodiment, and the same constitutions and members as those of the first embodiment will be denoted with the same reference numerals and described.

That is, the steps of FIGS. 3A to 3J in the present embodiment (the steps until the piezoelectric element 10 is bonded) are similar to those of FIGS. 2A to 2J of the first embodiment, and the description is omitted. In the present embodiment, as shown in FIGS. 3K and 3L, oxygen plasma etching is used to form the liquid discharge port (22). A resist 14 is allowed to function as an oxygen-resistant plasma film, and the liquid discharge port 12 (22) is etched in the first coat resin layer 3 by the oxygen plasma etching. This etching was ended at the arbitrary point in the soluble resin layer 4b. Subsequently, in the same manner as in the first embodiment, as shown in FIG. 3M, the soluble resin layer 4b is eluted to form the liquid flow path 13 (liquid pressurizing chamber (23) or liquid supply path (24)).

Even in the liquid jet head formed in this manner, in the same manner as in the liquid jet head of the first embodiment, the stable printing was possible, and the obtained printed matter had the high grade.

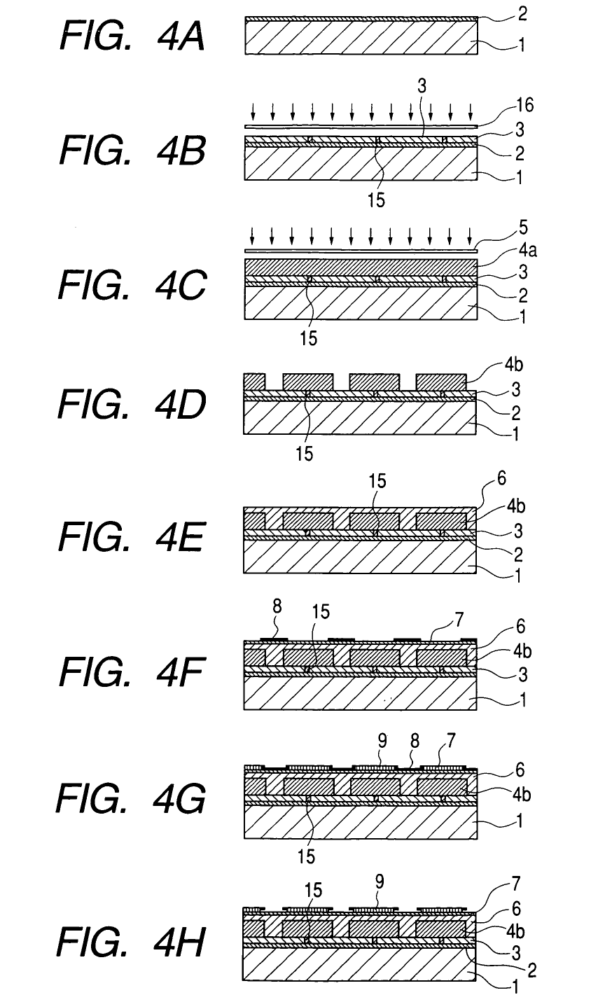

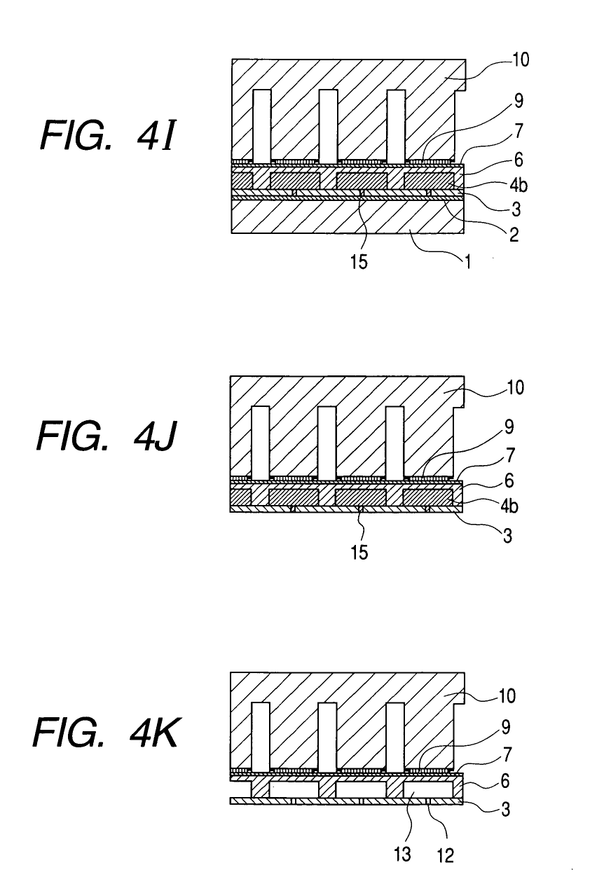

Next, a third embodiment of the manufacturing method of the liquid jet head according to the present invention will be described with reference to FIGS. 4A to 4K. FIGS. 4A to 4K show schematic step diagrams showing the major steps of the present embodiment in the sections. It is to be noted that also in the present embodiment, the same constitutions and members as those of the above-described embodiment will be denoted with the same reference numerals and described.

In FIG. 4A, the 5 mm thick substrate of glass having the heat resistance is used as the substrate 1 to form the separating layer 2 on the substrate 1. For the separating layer 2, PET is coated with soluble polymethyl isopropenyl ketone (ODUR-1010 manufactured by Tokyo Ohka Kogyo Co., Ltd.) and dried to form the dry film having the film thickness of 2 μm. The film was laminated and accordingly transferred onto the substrate 1. It is to be noted that ODUR-1010 has low viscosity and cannot be formed into the thick film, and was therefore condensed and used. Next, the substrate was pre-baked at 120° C. for 20 minutes.

Next, as shown in FIG. 4B, first, in order to form a part of the liquid flow path constituting member (29) constituting the partition wall of the liquid flow path (23, 24), the first coat resin layer 3 having a film thickness of 5 μm is formed on the separating layer 2 by the spin coat or roll coat. Moreover, to prepare a latent image 15 for securing the curing and liquid discharge port (22), the pattern is exposed.

As the first coat resin layer 3, the resin composition containing 100 parts of the epoxy resin (o-cresol novolak type epoxy resin), one part of the photo cation polymerization initiator (4,4-di-tbutylphenyl iodonium hexafluoroantimonate), and 10 parts of the silane coupling agent (A-187 manufactured by Nihon Yunika Co.) was dissolved in the methyl isobutyl ketone/xylene mixture liquid at a concentration of 50 wt %. The first coat resin layer 3 having a film thickness of 5 μm and having photosensitivity was formed on the separating layer 2 by the spin coat. Moreover, in order to prepare the latent image 15 for securing the curing and liquid discharge port (22), a mask 16 was used to expose the pattern by the mask aligner PLA520 (cold mirror CM290) manufactured by Cannon Inc.

Next, as shown in FIG. 4C, in order to form the liquid pressurizing chamber (23) and liquid supply path (24), the soluble resin layer 4a having a film thickness of 10 μm is formed on the first coat resin layer 3. As the resin layer 4a, PET is coated with soluble polymethyl isopropenyl ketone (ODUR-1010 manufactured by Tokyo Ohka Kogyo Co., Ltd.) and dried to form the dry film having a film thickness of 10 μm. The film was laminated and accordingly transferred onto the first coat resin layer 3. It is to be noted that ODUR-1010 has low viscosity and cannot be formed into the thick film, and was therefore condensed and used. Next, the layer was pre-baked at 120° C. for 20 minutes.

Subsequently, the mask 5 is used to expose the pattern of the liquid flow path by the mask aligner PLA520 (cold mirror CM290) manufactured by Cannon Inc. The exposure was carried out for 1.5 minute, methyl isobutyl ketone/xylene=2/1 was used for the development, and xylene was used for the rinse. Accordingly, as shown in FIG. 4D, the pattern 4b is formed by the soluble resin, and this pattern 4b is formed so as to secure the liquid pressurizing chamber (23) and liquid supply path (24).

Next, as shown in FIG. 4E, in order to form a part of the vibration plate (26), partition wall (28) of the liquid flow path, or liquid flow path constituting member (29), the second coat resin layer 6 having a film thickness of 5 μm on the pattern 4b and having the photosensitivity is formed on the pattern 4b by the spin coat or roll coat. As the second coat resin layer 6, the resin composition containing 100 parts of the epoxy resin (o-cresol novolak type epoxy resin), one part of the photo cation polymerization initiator (4,4-di-t-butylphenyl iodonium hexafluoroantimonate), and 10 parts of the silane coupling agent (A-187 manufactured by Nihon Yunika Co.) is dissolved in the methyl isobutyl ketone/xylene mixture liquid at the concentration of 50 wt %. The second coat resin layer 6 having a film thickness of 5 μm and having photosensitivity was formed on the pattern 4b by the spin coat and subsequently exposed to be cured.

Next, as shown in FIGS. 4F to 4H, the bond portion (27) for bonding the piezoelectric element is formed on the second coat resin layer 6. For this, first, as shown in FIG. 4F, the electrode layer 7 is formed by the electroless plating. Subsequently, the non-conductive photo resist layer having a film thickness of 5 μm is applied, and the pattern 8 is formed so as to agree with the shape of the bottom of the bond portion (27). Next, this is immersed in the electrolysis liquid for electroforming containing the aqueous liquid nickel ion containing 30 wt % of sulfamic acid, 0.5 wt % of nickel chloride, 4 wt % of boric acid, 1 wt % of the brightener, and 0.5 wt % of the pit preventive agent. The electrode layer 7 is used as the minus pole, and the electroforming is carried out at the current density of about 2 mA/cm². As a result, as shown in FIG. 4G, nickel in the electrolysis liquid is selectively deposited in the portion of the pattern 8 in which the photo resist layer is not formed, and the thickness of this portion increases. When the height of the pattern 8 of the photo resist layer was projected, and the pattern was developed to obtain a thickness of 18 μm, the overhang having a length of 10 μm was generated even in the surface direction of the pattern 8 of the photo resist layer by the edge effect, and the electric conduction was stopped. Next, as shown in FIG. 4H, the pattern 8 of the photo resist layer was washed away to form the bond portion 9 including the island structure whose section was of the rivet type.

Next, as shown in FIG. 4I, the epoxy-based adhesive is used to bond the piezoelectric element 10 to the bond portion 9 including the island structure. During the bonding of the piezoelectric element 10, since the substrate 1 or resin layer other than the bond portion 9 has the optical transmission, the alignment mark (not shown) formed on the piezoelectric element 10 is observed from the substrate 1 side with the stereomicroscope, and the piezoelectric element 10 can be bonded. As the stereomicroscope, SZH-10 (trade name) manufactured by Nikon Corp. was used. In this case, the position of the piezoelectric element 10 can accurately be determined with respect to the bond portion 9, and the position accuracy can be enhanced. After bonding the device through the epoxy-based adhesive, the device was pre-baked at 120° C. for 20 minutes.

Next, as shown in FIG. 4J, the ultrasonic wave is applied into methyl isobutyl ketone while immersing the material, the separating layer 2 between the substrate 1 and first coat resin layer 3 is eluted, and the substrate 1 is separated.

Next, as shown in FIG. 4K, the ultrasonic wave is applied into methyl isobutyl ketone while immersing the material, the latent image 15 is eluted, and the liquid discharge port 12 (22) is formed. Thereafter, the soluble pattern resin layer 4b is eluted, and the liquid flow path 13 (liquid pressurizing chamber (23) or liquid supply path (24)) is formed.

With respect to the liquid flow path 13 constituting the liquid pressurizing chamber (23) and liquid supply path (24) and the piezoelectric element 10 (21) formed in this manner, the liquid supply member (30) for supplying the liquid is bonded and the signal line and common line for driving the piezoelectric element 10 (21) which is the liquid discharge pressure generation device are electrically bonded so that the liquid jet head is completed.

In the same manner as in the first embodiment, the liquid jet head prepared in this manner was mounted on the liquid jet apparatus to perform the printing/recording. Then, the stable printing was possible, and the obtained printed matter was of the high grade.

The liquid jet head of the present invention prepared as described above is effective as the liquid jet head of a full line type which can simultaneously carry out the recording over the whole width of a recording sheet. Furthermore, the present invention is also effective for a color recording head in which the liquid jet head is integrally formed or a plurality of heads are combined. Moreover, the present invention can also be applied to a solid ink which is liquefied at a certain or higher temperature.

What is claimed is:

1. A manufacturing method of a liquid jet head, comprising:
a step of disposing a liquid flow path pattern containing a soluble resin on a substrate and disposing a coating layer containing a resin forming a wall of the liquid flow path so as to coat the liquid flow path pattern;
a step of disposing a liquid discharge energy generation element for generating an energy for use in discharging a liquid in a place disposed opposite to the liquid flow path pattern;
a step of separating and removing the substrate; and
a step of removing the liquid flow path pattern to form the liquid flow path.

2. The manufacturing method of the liquid jet head according to claim 1, further comprising: a step of forming a liquid discharge port in the coating layer between the step of separating and removing the substrate and the step of forming the liquid flow path.

3. The manufacturing method of the liquid jet head according to claim 1, wherein the step of disposing the liquid flow path pattern and the coating layer comprises: a step of forming a first coat resin layer on the substrate; a step of forming a liquid flow path pattern in a soluble resin on the first coat resin layer; a step of forming a second coat resin layer which constitutes a liquid flow path wall and vibration plate; and a step of forming a bond layer constituting a bond portion with respect to the liquid discharge energy generation element on the second coat resin layer.

4. The manufacturing method of the liquid jet head according to claim 3, further comprising: a step of forming a liquid discharge port in the first coat resin layer between the step of forming the first coat resin layer and the step of forming the liquid flow path pattern.

5. The manufacturing method of the liquid jet head according to claim 1, wherein the step of separating and removing the substrate comprises: eluting a separating layer of a soluble resin formed on the substrate.

6. The manufacturing method of the liquid jet head according to claim 1, wherein the coating layer contains a solid epoxy resin at room temperature.

7. The manufacturing method of the liquid jet head according to claim 6, further comprising the step of forming the coating layer on the substrate by spin coat or roll coat.

8. The manufacturing method of the liquid jet head according to claim 1, wherein the substrate and the layer of the resin formed on the substrate have optical transmission.

9. The manufacturing method of the liquid jet head according to claim 1, wherein the liquid discharge energy generation element is a piezoelectric element.
